(19) United States
(12) Patent Application Publication
(10) Pub. No.: US 2015/0232129 A1
(43) Pub. Date: Aug. 20, 2015

(54) CONNECTION ARRANGEMENT AND METHOD FOR MANUFACTURING A CONNECTION ARRANGEMENT AND AUTOMOTIVE COMPONENT

(71) Applicant: Benteler Automobiltechnik GmbH, Paderborn (DE)

(72) Inventor: HANS-GEORG GRUNDMEIER, Paderborn (DE)

(73) Assignee: Benteler Automobiltechnik GmbH, Paderborn (DE)

(21) Appl. No.: 14/623,276

(22) Filed: Feb. 16, 2015

(30) Foreign Application Priority Data
Feb. 17, 2014 (DE) 10 2014 101 979.2

(51) Int. Cl. B62D 27/02; B22D 19/00; B22D 19/04

(52) U.S. Cl. CPC B62D 27/02; B22D 19/04; B22D 19/0081

(57) ABSTRACT

A connection arrangement between a casting made of light metal and a steel profile, wherein the steel profile is indirectly connected to the casting by way of a metallic coupling element having an open or a closed profile. One end of the coupling element is at least partially expanded and over-molded. Automotive components composed of one or more castings and steel profiles can be produced with this type of connection arrangement, which can have an arbitrarily complex structure. In a suitable manufacturing process, the coupling element can first be over-molded by a casting, which is constructed as a hollow component employing a casting core, and thereafter be materially connected to the steel profile, thus avoiding direct connection between the steel profile and the casting.

### CROSS-REFERENCES TO RELATED APPLICATIONS

This application claims the priority of German Patent Application, Serial No. 10 2014 101 979.2, filed Feb. 17, 2014, pursuant to 35 U.S.C. 119(a)-(d), the content of which is incorporated herein by reference in its entirety as if fully set forth herein.

### BACKGROUND OF THE INVENTION

The present invention relates to a connection arrangement between a casting made of light metal and steel profile as well as a method for manufacturing such a connection arrangement. Furthermore, the invention relates to an automotive component having a plurality of castings made of a light metal, which are interconnected by one or more steel profiles.

The following discussion of related art is provided to assist the reader in understanding the advantages of the invention, and is not to be construed as an admission that this related art is prior art to this invention.

Light metals as materials for lightweight components are indispensable in the modern automotive industry. Materials such as aluminum or magnesium can be formed into very complex geometries by casting or extrusion processes. The shape can be varied in almost any conceivable manner. Disadvantageously, however, light metals have a relatively low stiffness compared to steel materials typically used in the automotive industry. Although steel materials are less expensive than light metal materials, they are, however, inferior in terms of shaping and weight. Thus, efforts to combine the material properties of both material groups are increasing.

However, the problem arises that these materials are generally very difficult to interconnect materially. Several methods are known in the prior art to overcome this obstacle.

It would therefore be desirable and advantageous to obviate prior art shortcomings and to provide an improved connection arrangement adapted to interconnect light metal components with steel components, wherein the connection arrangement can be produced in a very simple and cost-effective manner, and can accommodate the lightweight requirements of modern automobile manufacture and guarantee a stable and permanent connection. Furthermore, it would also be desirable and advantageous to provide a method for manufacturing such a connection arrangement as well as to propose such an automotive component, which is composed of several castings made of light metal, which are interconnected by one or more steel profiles.

### SUMMARY OF THE INVENTION

According to one aspect of the present invention, a connection arrangement for interconnecting a casting made of light metal and steel profile, includes a metallic coupling element constructed as an open profile or a closed profile and having first and second end portions, and configured to indirectly connect the steel profile to the casting, wherein the first end portion of the coupling element is at least partially expanded and over-molded by the casting and the second end portion of the coupling element is materially connected with the steel profile.

The coupling element thus serves as an adapter for connecting the castings made of light metal and the steel profiles, because a direct connection is normally difficult to produce. Preferably, the coupling element is also made of a steel material, especially galvanized steel.

The coupling element is an open profile or a closed profile. The coupling element may be, for example, a short section of tube made from a steel material, which may be peripherally open or closed. The coupling element has for example a cylindrical shape when the profile is closed and has, for example, a U-shaped cross-section when the profile is open. Depending on the needs and requirements placed on the workpiece, however, the coupling element may have any cross-section, even a cross-section that varies along its length.

The steel profiles employed here may have an open or a closed circumference. The steel profiles may also be bent before or after joining with the casting made of light metal. Ideally, they may also be provided with connections for additional components. Openings to reduce weight or even for connection purposes may be incorporated in the steel profile.

Materials that are typically used in the automobile industry may be used for the steel profile. In particular, galvanized steels are used as these already have corrosion protection, thus obviating the need for a later coating.

In particular, thin-wall steel profiles made of high-strength materials are used to further reduce the weight. It is also possible to use spatially more extended sheet metal shells that simultaneously interconnect several castings instead of classic elongated steel profiles.

Light metals, such as aluminum or magnesium, are used for the castings. These materials can be very easily processed and are used in a wide variety of casting processes. Manufacturing processes may include die casting, chill casting and other customary casting processes.

An end portion of the coupling element is over-molded by the casting and another end portion of the coupling element is materially connected with the steel profile.

The coupling element thus permanently and securely interconnects the casting and the steel profile. On the one hand, the coupling element is materially connected with the steel profile, with a connection method being here, for example, welding or soldering. The connection may be readily generated by a customary welding process, such as MAG welding or laser welding. Such a process step thus does not require complex equipment and can be implemented with relatively few resources and expertise.

Conversely, the coupling element is connected with the casting by a positive interlock. For example, the end portion of the coupling element which is over-molded by the casting may be expanded at least in certain regions. The term expansion is to be understood that the cross section of the coupling element is expanded either continuously or in several successive discrete steps toward the end that is over-molded by the casting. For example, the end portion may be designed to have a trumpet shape or a funnel shape. Expansion of the end portion that is over-molded by the casting creates an undercut which improves the positive connection between the coupling element and the casting. This produces a more stable connection between the two components.

It is thus not necessary to interconnect, for example, aluminum or magnesium and a steel material directly by welding or soldering. This results in an advantageous combination of the materials for lightweight construction. The respective positive material properties and processability are employed, whereby in particular the complementary properties play a role. Complex castings can be produced due to the easy processability of the light metal in a casting process. The lack of rigidity of aluminum or magnesium materials is compensated by the high-strength material properties of the steel profiles, which are in turn difficult to machine and may therefore not provide the entire component with essentially adequate load bearing capacity and stiffness.

Simple casting tools can be used in the production of the castings. The coupling elements are relatively small compared to the steel profiles and thus easier to handle in a casting tool, while at the same time the tightness of the casting tool during the casting process can be more easily attained than with long steel profiles. The risk of warpage is much lower than would be the case when an entire steel frame would be over-molded even after or during removal of the casting from the casting tool. Also, the heat introduced in the steel during the casting process is minimized and there is no longer the risk that liquid aluminum penetrates into the hollow steel profiles, which would also cause an undesirable introduction of heat into the steel.

According to another feature of the present invention, the coupling element at the end portion that is over-molded by the casting may include at least one positive-locking element. The positive-locking element may, for example, be a bead, a recess, an opening, a bulge and the like. The liquid light metal can then penetrate the positive-locking element during the casting process or engage in the form-locking element, thereby producing a more stable connection between the coupling element and the casting. The improved positive fit is produced because the casting penetrates the coupling element or forms an undercut.

According to another feature of the present invention, the end of the coupling element connected with the steel profile may have an outer contour that is complementary to the inner contour of the steel profile, so that the steel profile can be placed onto the coupling element; alternatively, the end of the coupling element connected with the steel profile may have an inner contour that is complementary to the outer contour of the steel profile so that the coupling element can be placed onto the steel profile. This design of the invention advantageously improves the manufacturing process. When components are to be welded directly with their abutting end surfaces, the components must be held in a clamping device for welding. Even small deviations in the tolerances or warping during welding may give rise to a non-optimal result. By placing the two components onto each other, they are already fixed in position relative to each other, so that a corresponding clamping device can have a correspondingly simpler design and the welded seam can be applied with high precision and minimum warpage.

The welded seam then connects the particular edge at the end portion of the respective outer component with the outer surface of the inner component.

This measure is particularly advantageous when both components are closed profiles; however, open profiles can also be placed on each other. However, it is important to provide matching inner and outer contours so as to prevent displacement of the two components relative to each other.

According to another feature of the present invention, this plug-connection can be made more stable by forming a non-positive connection between the overlapping sections of the coupling element and the steel profile. By placing the two components on top of one another, an interference fit is formed which, on the one hand, prevents the two components from moving relative to each other during and before welding. At the same time, the connection between the coupling element and the steel profile further improves the welded or material connection. This also has a positive effect on the service life since the welded seam incurs less damage when the connected components are stressed.

According to another aspect of the invention, the invention is also directed to a method for manufacturing a connection arrangement between a casting and a steel profile, wherein a casting core, in particular a sand core and a metallic coupling element, are inserted into a casting tool and a casting of a light metal is made subsequently cast, wherein the casting core and an end portion of the coupling element are over-molded, wherein the casting core is removed after the casting has been produced, thereby forming a hollow casting, and wherein subsequently a steel profile is connected with another free end portion of the coupling element.

The casting tools used here can have a simple and compact design. Only the coupling elements that have relatively small dimensions and not the relatively long steel profiles are processed in the casting tool, thus automatically reducing the dimensions of the casting tools. Corresponding casting tools are also easier to seal.

The casting core is over-molded during the casting process with the liquid light material. The material is optimally utilized by producing a hollow casting, making the entire component less expensive and also lighter. When the coupling element is a hollow profile, the casting core can be easily removed after the casting process through the coupling element. Conversely, if the steel profiles were connected directly with the casting, the casting core would have to remain in the finished component, because it could no longer be removed without causing a problem.

After removal of the casting from the casting tool, additional processing steps may be performed, such as deburring, sanding or surface cleaning.

Attaching the steel profiles to the coupling elements at a later time also prevents liquid light metal from penetrating the steel profiles during casting, which would lead to an unwanted introduction of heat and thus a change in the material properties and possibly warping in the structure of steel profiles. If an already completed steel frame would have to be provided with the castings, there would be a risk of warpage when the frame is removed. Since smaller tools can be used, the costs for the production of components using this method are also reduced which makes this method more attractive for use in mass production.

The casting and coupling element may also not have to be removed from the casting tool immediately following the casting process; instead, the casting tool may be used as a fixative device for clamping the coupling element before the welding process, so that the casting tool operates as part of a clamping tool which fixed the position of the steel profile and the coupling element prior to joining.

A coupling element may also be designed to have several free end portions, which would allow several steel profiles to be connected to the coupling element.

Preferably, the coupling element is connected with the steel profile materially and/or non-positively. A material connection between the two components can be attained by using customary joining techniques, such as welding or soldering. A wide variety of industrial welding processes can be employed, such as MAG welding or laser welding.

A non-positive connection can be formed by placing the coupling element and the steel profile onto each other, wherein the two components form an interference fit in the overlapping region. This has the particular advantage that the mutual position of both components is already fixed for a subsequent material connection. Either the steel profile may be placed on the coupling element or the coupling element may be placed on the steel profile.

Additionally, both components are fixed in relation to each other in a welding apparatus. This is particularly important when there is no non-positive or plug connection between the two components, so that the two components must be interconnected at their respective edges by a butt joint.

The steel profile may be bent and/or mechanically processed before or after making the connection with the coupling element. This is particularly useful for an optimum utilization of installation space, the introduction of feedthroughs or a connection with additional components of a vehicle or for reducing the weight.

Furthermore, according to the method of the invention, at least one form-fitting element is formed on the coupling element before over-molding. A form-fitting element may be a bead or a recess or an opening or a bulge and the like. These form-fitting elements are customarily introduced in the coupling element by mechanical processing, such as cutting, stamping, die cutting or by other forming methods. The form-fitting elements are intended to improve the connection between the casting and the coupling element through an additional positive connection.

Preferably, the coupling element is placed on the casting core before being inserted in the casting tool. The casting core has for this purpose a lug which the coupling element fully or partially fills, thereby fixing the relative mutual position of the casting core and coupling element. As a result, the wall thickness of the casting is highly repeatable, while at the same time casting cores and coupling elements can be more easily handled when placed in the casting tool. For example, in series production, coupling elements that are already finally placed on the casting cores can be provided for the casting process, allowing the casting tools to be loaded more quickly and thus reducing cycle times.

According to another preferred embodiment of the present invention, a plurality of coupling elements may be inserted into the casting tool and over-molded during production of the casting. Especially in the manufacture of more complex structures, a casting can then be connected with several other castings by way of the steel profiles. Since a casting can have an almost arbitrary shape, a casting according to the invention has wide shape variability, so that support structures of essentially any design can be produced. If a steel profile and a casting were interconnected directly, each steel profile would have to be individually connected to the casting, for example with welding connections, which would expose the casting to a renewed introduction of heat. If several steel profiles were to be connected with a casting in a casting tool, this would pose additional design challenges for the casting tool. In addition, the casting tools would have to be sufficiently large for accommodating all steel profiles, which would in turn entail large financial investments.

According to yet another aspect of the invention, an automotive component includes a plurality of castings made of a light metal, which are interconnected by one or more steel profiles. The castings and the steel profiles are connected to each other by a connection arrangement as described above. Examples for automotive components according to the invention are, for example, subframes or torsion beam axles or integral subframes.

For example, subframes should have a high stiffness to accommodate the applied forces. At the same time, they are equipped with different types of connection points to which additional components such as control arms and the like are to be connected. This particular example illustrates best the advantages of the respective materials. Steel profiles serve as rigid supports of simple design, whereas the castings are more complex and reduce the weight. Since the steel profiles have no complex shape, high-strength steels can be used, which is also advantageous for a lightweight structure.

According to another feature of the present invention, connections for other automotive components may be formed on the castings and/or the steel profiles. Complex structures are relatively easy to manufacture with the castings because almost any configuration can be realized with the casting process. It is possible to introduce recesses or openings or to attach connection elements, for example by welding, even with a steel profile. Both castings and steel profiles can be further processed or machined after producing the indirect connection between the two components. In particular, the steel profile can be bent and/or mechanically processed before or after connection with the coupling element.

According to another advantageous embodiment of the invention, the castings may be hollow castings, which further enhance the lightweight concept. In addition, the usually expensive light metal can be used more effectively and in a cost-saving manner.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a connection arrangement according to the present invention with a casting core;

FIG. 2 shows another embodiment of a connection arrangement according to the present invention;

FIG. 3 shows a connection arrangement according to the present invention with several coupling elements and steel profiles;

FIG. 4 shows a method according to present the invention for manufacturing a connection arrangement with a casting core;

FIG. 5 shows a torsion beam axle with a connection arrangement according to the present invention; and

FIG. 6 shows a subframe with a connection arrangement according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

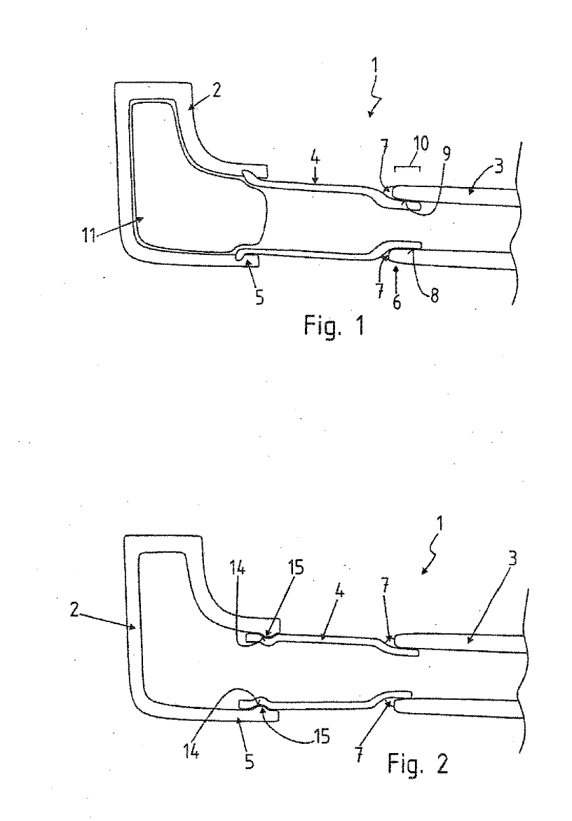

Turning now to the drawing, and in particular to FIG. 1, there is shown a connection arrangement 1 between a casting 2 made of light metal and a steel profile 3, wherein the steel profile 3 is indirectly connected with the casting 2 by way of a metallic coupling element 4. A first end portion 5 of the coupling element is over-molded by the casting 2. The first end portion 5 is regionally expanded and forms a funnel, which is surrounded by the material of the casting 2, so that the coupling element 4 is positively connected with the casting 2. A second end portion 6 of the coupling element 4 is materially connected with the steel profile 3. The material connection is produced by a welded seam 7. A second end portion 6 was formed prior to producing the material connection such that its outer contour 8 is formed complementary to the inner contour 9 of the steel profile 3. This allows the steel profile 3 to be placed on the coupling element 4, whereby an interference fit is formed between the two components. This interference fit is then located in the overlapping region 10 of the two components.

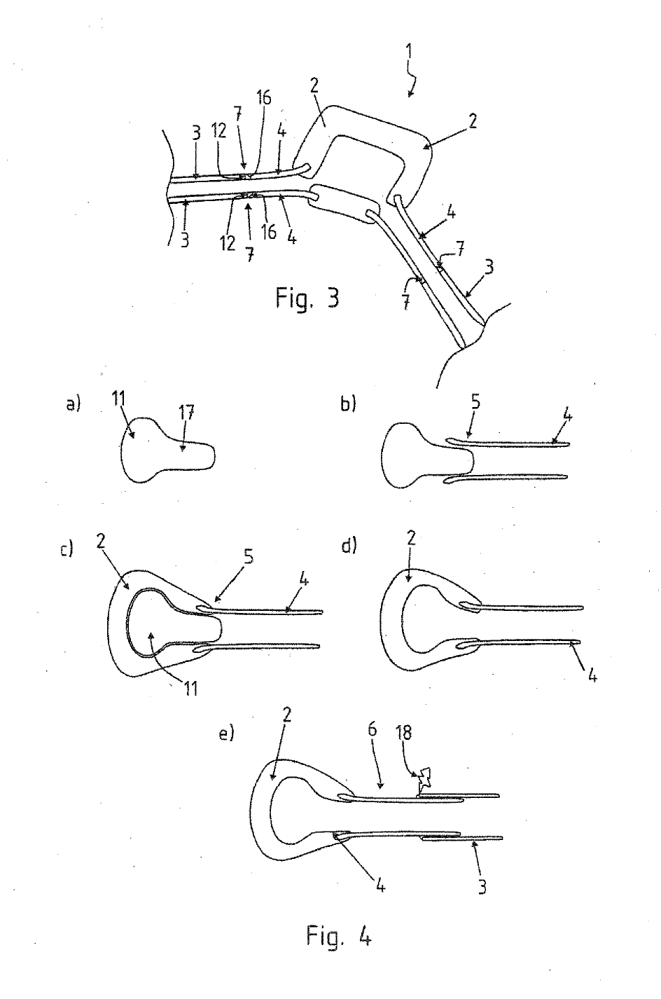

The casting 2 in this exemplary embodiment is hollow and filled by a casting core 11. In this exemplary embodiment, the core is a so-called lost core which remains in the casting 2. In contrast, the casting core 11 in the exemplary embodiment in FIG. 3 was removed after the casting 2 was produced, leaving the empty hollow casting 2 behind.

FIG. 2 shows for comparison a conventional connection arrangement 1. The connection between the casting 2 and the coupling element 4 is here aided by positive-locking elements 14. However, the end portion 5 of the coupling element 4 that is over-molded by the casting 2 is not at least partially expanded. The positive-locking elements 14 are formed in the first end portion 5 of the coupling element 4. The positive-locking element 14 in this embodiment is a bead which was introduced in the circumferential direction of the coupling element 4 and points radially inwardly. The material of the casting engages in this bead, forming an undercut 15, which ensures the positive lock between the casting 2 and the coupling element 4. Disadvantageously, however, corresponding positive-locking elements 14 must be introduced into the coupling element 4 by using relatively complex additional tools.

Another exemplary embodiment of a connection arrangement 1 according to the invention is shown in FIG. 3, where several steel profiles 3 are connected with the casting 2 by way of a respective coupling element 4. For example, this may be a cast node for a subframe. The casting 2 is in this example hollow to reduce weight and costs. The coupling elements 4 are connected to the steel profiles 3 by way of a welded seam 7, wherein in each case the edge 12 at the end of the steel profile is connected with the corresponding edge 16 at the end of the coupling element 4 by a butt joint.

FIG. 4 illustrates the manufacturing process for the connection arrangement according to the present invention by using a casting core 11 for producing a hollow casting 2. First, the casting core 11 is provided (FIG. 4a). This casting core 11 has a lug 17 on which a first end portion 5 of the coupling element 4 is placed (FIG. 4b). The casting core together with the coupling element 4 is then inserted in a casting tool, whereafter a casting 2 made of a light metal is cast. The end portion 5 of the coupling element is over-molded with the light metal (FIG. 4c). The coupling element 4 and the casting 2 hereby form a positive connection which is additionally supported by the expanded end of the end section 5. The casting core 11 is then removed through the coupling element 4, leaving a hollow casting 2 (FIG. 4d). Lastly, a steel profile 3 is materially connected by way of a welded seam 18 with another free end portion 6 of the coupling element 4.

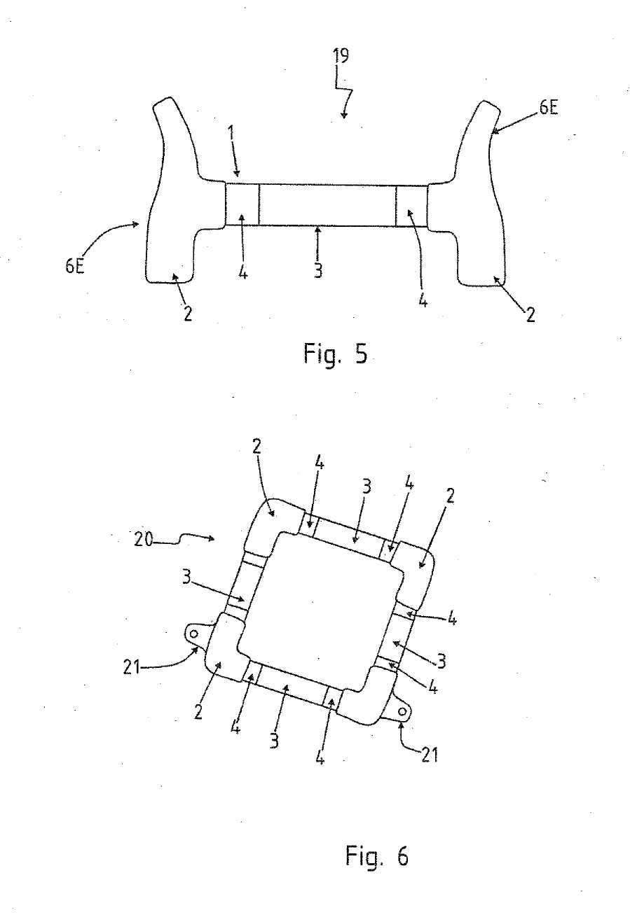

FIGS. 5 and 6 show two exemplary embodiments of an automotive component according to the invention that include several castings 2 that are interconnected by steel profiles 3, each forming a connection arrangement 1 according to the invention. FIG. 5 shows a torsion beam axle 19 with two longitudinal control arms designed as castings 2 and interconnected by a steel profile 3, namely the cross member.

FIG. 6 shows a subframe 20 having a plurality of castings 2 as node elements, which are interconnected by steel profiles 3. The connection consists of a connection arrangement 1 according to the invention, wherein a corresponding coupling element 4 is arranged between the castings 2 and the steel profiles 3. Two coupling elements 4 and steel profiles 3 are here assigned to each casting 2. For this exemplary embodiment, the individual castings 2 with the coupling elements 4 are preferably produced first. The castings 2 can have any shape, so that a large number of connections 21 for additional vehicle components can be designed.

The semi-finished products consisting of the casting 2 and the coupling elements 4 are then sequentially joined with the steel profiles 3, forming a subframe from one component after the other. It is easy conceivable that much more complex support structures can be produced in this way, by successively joining the individual components together.

Independently thereof, it is also possible in this embodiment to fix the position of all castings 2 and coupling elements 4 together with the steel profiles 3 and to interconnect the individual components simultaneously. The procedure depends in particular on the complexity of the supporting structure to be produced with the resources according to the invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A connection arrangement for interconnecting a casting made of light metal and steel profile, comprising:
a metallic coupling element constructed as an open profile or a closed profile and having first and second end portions, and configured to indirectly connect the steel profile to the casting,
wherein the first end portion of the coupling element is at least partially expanded and over-molded by the casting and the second end portion of the coupling element is materially connected with the steel profile.

2. The connection arrangement of claim 1, wherein the coupling element comprises at least one positive-locking element disposed in the first end portion.

3. The connection arrangement of claim 1, wherein the second end portion has an outer contour that is complementary to an inner contour of the steel profile, allowing the steel profile to be placed over the coupling element to form an overlapping region.

4. The connection arrangement of claim 1, wherein the second end portion has an inner contour that is complementary to an outer contour of the steel profile, allowing the coupling element to be placed over the steel profile to form an overlapping region.

5. The connection arrangement of claim 3, wherein the overlapping region forms a non-positive connection between the coupling element and the steel profile.

6. The connection arrangement of claim 4, wherein the overlapping region forms a non-positive connection between the coupling element and the steel profile.

7. A method for producing a connection arrangement between a casting and a steel profile, comprising:
inserting a casting core and a metallic coupling element in a casting tool;
producing a casting made of a light metal by a casting process, wherein the casting core and a first end portion of the coupling element are over-molded;
removing the casting core after the casting has been produced, thereby forming a hollow casting, and
subsequently connecting the steel profile to a second free end portion of the coupling element.

8. The method of claim 7, wherein the casting core is a sand core.

9. The method of claim 7, wherein the second end portion of the coupling element is materially connected with the steel profile.

10. The method of claim 7, wherein the second end portion of the coupling element is non-positively connected with the steel profile.

11. The method of claim 7, further comprising forming at least one positive-locking element on the coupling element before over-molding.

12. The method of claim 7, wherein the coupling element is placed on the casting core before insertion into the casting tool.

13. The method of claim 7, wherein a plurality of coupling elements are inserted in the casting tool and over-molded.

14. The method of claim 7, wherein the first end portion of the coupling element is at least partially expanded before being over-molded.

15. An automotive component comprising:
a plurality of castings made of a light metal and interconnected by one or more steel profiles, and
a connecting arrangement comprising a metallic coupling element constructed as an open profile or a closed profile and having first and second end portions, and configured to indirectly connect the steel profile to the a plurality of castings,
wherein the first end portion of the coupling element is at least partially expanded and over-molded by the casting and the second end portion of the coupling element is materially connected with the steel profile.

16. The automotive component of claim 15, wherein at least one of the castings and the steel profiles comprise connections for additional automotive components.

17. The automotive component of claim 15, wherein the castings are hollow.
